(19) United States
(12) Patent Application Publication
(10) Pub. No.: US 2015/0116297 A1
(43) Pub. Date: Apr. 30, 2015

(54) CIRCUITS AND METHODS FOR SWITCHING OF MEMS SYSTEMS

(71) Applicant: PIXTRONIX, INC., San Diego, CA (US)

(72) Inventors: Nikolay I. Nemchuk, North Andover, MA (US); Jianguo Yao, Londonderry, NH (US)

(73) Assignee: PIXTRONIX, INC., San Diego, CA (US)

(21) Appl. No.: 14/063,762

(22) Filed: Oct. 25, 2013

(51) Int. Cl. G02B 26/02; G09G 3/34

(52) U.S. Cl. CPC G02B 26/02; G09G 3/3486; G09G 2330/021
USPC 345/212; 359/230; 345/109

(57) ABSTRACT

This disclosure provides systems, methods and apparatus for addressing an array of pixels in a display. In one aspect, an electromechanical device includes a movable element coupled between a first and second actuator, and a charge distribution circuit arranged to electronically couple the first actuator to the second actuator and capable of equalizing a potential between the first actuator and the second actuator. In certain implementation, a method for addressing an array of pixels in a display, where a given pixel in the array of pixels includes a light modulator coupled between first and second actuator capacitors, includes equalizing a potential between the first actuator capacitor and the second actuator capacitor prior to discharging and re-charging the actuator capacitors. Equalizing a potential may include transferring charge from one actuator capacitor to another actuator capacitor until the voltage across each actuator capacitor is approximately equal.

### TECHNICAL FIELD

This disclosure relates to the field of displays, and particularly to circuits for controlling displays with movable electromechanical system elements, and methods for operating the same.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers.

Dual-actuated MEMS shutter displays, displays having two actuators to move a shutter, are known in the art. Actuation of these known dual-actuated MEMS shutter displays requires pre-charging both first and second actuator capacitors coupled to the first and second actuators, and discharging one of the first and second actuator capacitors to move the MEMS shutter. For example, to move a dual-actuated shutter both actuator capacitors are pre-charged to an actuation voltage high enough to move the shutter. Then, one of the first and second actuator capacitors is discharged to move the shutter to its intended position. Discharging a capacitor for every shutter switching event is understood to result in a power loss proportional to the capacitance of the capacitor multiplied by the voltage across the capacitor, squared (CV²). Thus, with each shutter switching event, approximately CV² of power is wasted as a result of the actuator capacitor discharge process. In addition, extra time is required to discharge one of the two capacitors and/or fully charge the second of the two capacitors from a ground potential to an actuation voltage potential prior to switching the shutter. It would be beneficial to have a system and method for actuating a dual-actuated MEMS light modulator while saving power and increasing light modulator switching speed. In particular, it would be beneficial to reduce the amount of power wasted when discharging and charging the actuator capacitors of a dual-actuated MEMS system. It would also be beneficial to reduce the amount of time it takes to discharge and charge the actuator capacitors of a dual-actuated MEMS system.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical device including a movable element being movably responsive to a first actuator and a second actuator, the first actuator including a first capacitor and the second actuator including a second capacitor, and a charge distribution circuit arranged to electronically couple the first capacitor to the second capacitor and capable of equalizing a potential between the first capacitor and the second capacitor.

In some implementations, the charge distribution circuit can include a single switch. In some implementations, the charge distribution circuit can include at least a first switch and a second switch. In some implementations, the charge distribution circuit can include a voltage interconnect coupled to the first switch and the second switch.

In some implementations, the electromechanical device can include a display, a processor that is configured to communicate with the display, the processor being configured to process image data, and a memory device that is configured to communicate with the processor. In some implementations, the electromechanical device can include a driver circuit configured to send at least one signal to the display, and a controller configured to send at least a portion of the image data to the driver circuit. In some implementations, the electromechanical device includes an image source module configured to send the image data to the processor, where the image source module includes at least one of a receiver, transceiver, and transmitter. In some implementations, the electromechanical device includes an input device configured to receive input data and to communicate the input data to the processor.

Another innovative aspect of the subject matter described in this disclosure can be implemented in a display including an array of pixels including, for each pixel, a first actuator capacitor, a second actuator capacitor and a light modulator being electronically coupled to the first and second actuator capacitors, and a control matrix associated with the array of pixels including, for each pixel: a charge distribution circuit arranged to electronically couple the first actuator capacitor to the second actuator capacitor, and equalize a potential between the first actuator capacitor and the second actuator capacitor.

In some implementations, the charge distribution circuit can include a single switch. In some implementations, the charge distribution circuit can include at least a first switch and a second switch. In some implementations, the charge distribution circuit can include a voltage interconnect coupled to the first switch and the second switch

Another innovative aspect of the subject matter described in this disclosure can be implemented in a method for addressing an array of pixels in a display where a given pixel includes a light modulator coupled between first and second actuator capacitors. The method includes equalizing a first potential of the first actuator capacitor and a second potential of the second actuator capacitor, loading data to the array of pixels, and for a given pixel, discharging the first actuator capacitor based on the data, re-charging the second actuator capacitor to an actuation voltage based on the data, and causing the light modulator to move in response to a potential difference between the light modulator and at least one of the first and second actuator capacitors.

In some implementations, the potential between the first actuator capacitor and the second actuator capacitor is equalized prior to discharging the first actuator capacitor and prior to causing the light modulator to move. In some implementations, equalizing the potential between the first actuator capacitor and the second actuator capacitor can include moving charge from a high level node to a low level node. In some implementations, equalizing the potential between the first actuator capacitor and the second actuator capacitor can include applying a first voltage to both the first actuator capacitor and the second actuator capacitor.

In some implementations, the first voltage can be approximately half of the actuation voltage. In some implementations, discharging the first actuator capacitor can include discharging approximately half of the actuation voltage. In some implementations, re-charging the second actuator capacitor can include re-charging from approximately half of the actuation voltage. In some implementations, loading data to the array of pixels can include setting a latch in a first state.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A is an example of a display apparatus having MEMS elements.

FIG. 1B is a block diagram of the display apparatus of FIG. 1A.

FIG. 2A depicts in more detail a light modulator of the type depicted in FIG. 1A.

FIG. 2B depicts an alternate implementation of a light modulator of the type depicted in FIG. 1A.

FIG. 3A is a schematic diagram of a control matrix suitable for controlling the light modulators of the display apparatus of FIG. 1A.

FIG. 3B is a perspective view of an array of shutter-based light modulators connected to the control matrix of FIG. 3A.

FIGS. 4A and 4B are plan views of a dual-actuated light modulator assembly in the open and closed positions, respectively.

FIG. 5 is a circuit diagram of control circuitry for controlling a dual-actuated light modulator.

FIG. 6 is a circuit diagram of control circuitry for controlling a dual-actuated light modulator including a charge distribution circuit.

FIG. 7 is a block diagram of a method for operating the circuit of FIG. 6.

FIG. 8 is a circuit diagram of an alternate implementation of control circuitry for controlling a dual-actuated light modulator.

FIG. 9 is a timing diagram of a method of driving a circuit, such as the circuit of FIG. 8.

FIG. 10 is a block diagram of a method for operating the circuit of FIG. 8.

FIG. 11 is a circuit diagram of an alternate implementation of control circuitry for controlling a dual-actuated light modulator.

FIG. 12 is a block diagram of a method for operating the circuit of FIG. 11.

FIGS. 13A and 13B are system block diagrams illustrating a display device that includes a plurality of MEMS light modulator display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In certain implementations described herein, an electromechanical device may be provided with a charge distribution circuit for equalizing a potential between at least two actuator capacitors. The charge distribution circuit may be part of control circuitry for controlling a light modulator in an array of pixels of a display device. The electromechanical device may include a movable element (e.g., a light modulator) coupled between a first actuator and a second actuator, the first and second actuators being capable of moving the movable element between at least two positions. The first and second actuators may include first and second capacitors, respectively, for storing a potential. The stored potential may be used to create an electrostatic force to move the movable element. The charge distribution circuit may be arranged to electronically couple the first capacitor to the second capacitor to equalize a potential between the first capacitor and the second capacitor. For example, equalizing the potential may include transferring charge from one capacitor to the other capacitor until the voltage across each actuator capacitor is approximately equal.

In certain implementation described herein, a method for addressing an array of pixels in a display device is provided. A given pixel in the array of pixels may include a light modulator coupled between first and second actuator capacitors. The method may equalize a potential between the first actuator capacitor and the second actuator capacitor prior to moving the light modulator to an intended position. For example, equalizing the potential may include transferring charge from one actuator capacitor to the other actuator capacitor until the voltage across each actuator capacitor is approximately equal. After the voltage is equalized across the actuator capacitors, the method may proceed with loading data to the array of pixels, and for a given pixel, discharging the first actuator capacitor based on the data, and re-charging the second actuator capacitor to an actuation voltage based on the data. Discharging the first actuator capacitor may include discharging less voltage and in a shorter time when compared to a method that does not include potential equalization. Similarly, re-charging the second capacitor may include re-charging less voltage and in a shorter time when compared to a method that does not include potential equalization. The method may further include causing the light modulator to move in response to a potential difference between the light modulator and at least one of the first and second actuator capacitors.

Particular implementations of the subject matter described in this disclosure can be implemented to realize one or more of the following potential advantages. The systems and methods described herein may reduce power loss during light modulator switching events by distributing charge between first and second actuator capacitors in a dual-actuated light modulator assembly to equalize the potential between the first actuator capacitor and the second actuator capacitor prior to moving the light modulator. Discharging a capacitor from a full actuation voltage for every light modulator switching event is understood to result in a power loss proportional to CV², where C is the capacitance and V is the voltage across the capacitor. In addition, extra time is required to discharge the first capacitor and to fully charge the second capacitor from a ground state prior to moving the light modulator. In the systems and methods described herein, instead of pre-charging both actuator capacitors to an actuation voltage, charge is distributed from the previously charged capacitor to the previously discharged capacitor. After charge equalization between the capacitors, one capacitor is discharged and the other capacitor is re-charged to the actuation voltage level to move the shutter. As a result, power is saved because only half of the total charge is discharged from the low node capacitor, and the high node capacitor does not have to be charged from a ground state. Additionally, control circuit operation is faster because it takes a shorter amount of time to discharge only half of the actuation voltage from the capacitor. Furthermore, it requires less time to charge the opposing actuator to a full actuation voltage when starting from about one-half of the actuation voltage level instead of starting from a ground voltage.

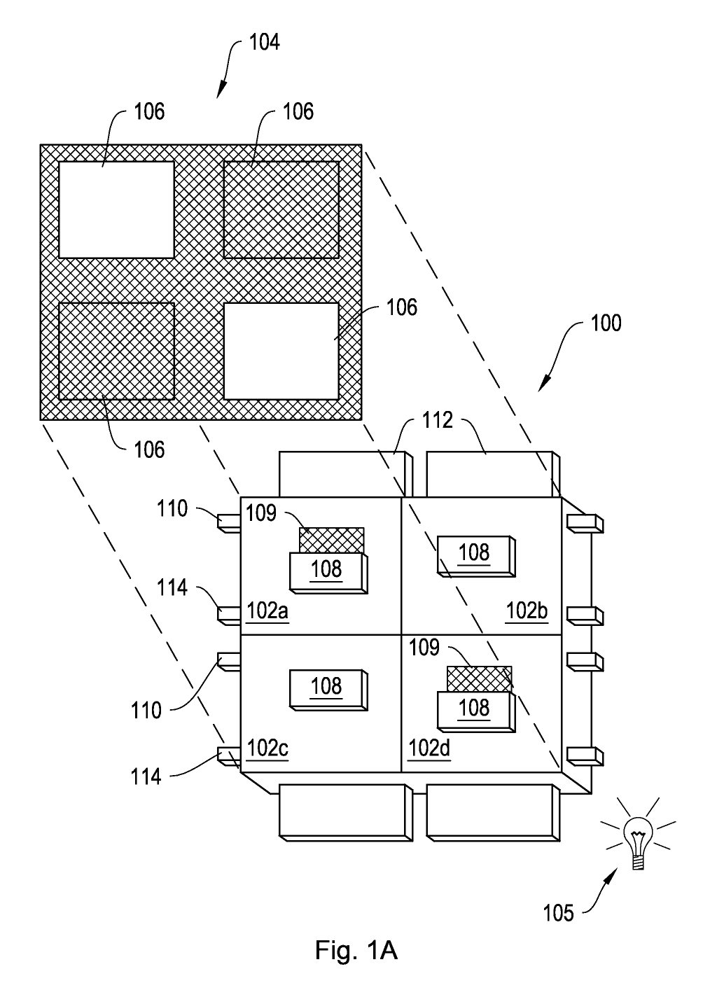

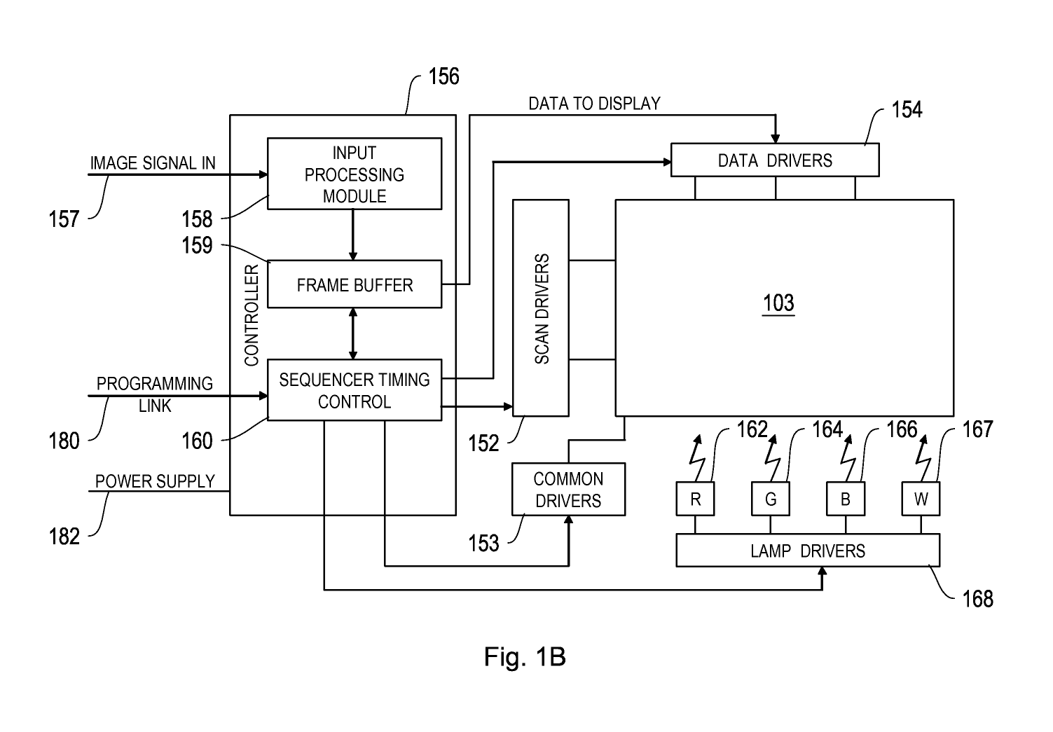

FIG. 1A is an example of a display apparatus 100, according to an illustrative implementation. The display apparatus 100 includes a plurality of MEMS light modulators 102a-102d (generally “light modulators 102”) arranged in rows and columns. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can form an image 104 for a backlit display, if illuminated by a lamp or lamps 105. Setting the state of a MEMS modulation, such as MEMS modulator 102a, involves actuating the MEMS modulator 102a to move an element within the modulator 102a from a first position to a second position. The MEMS modulators 102a-102d may include a single actuator to move the light modulator, or may include a dual-actuator configuration. In a dual-actuator configuration a shutter 108 may be positioned between a first actuator and a second actuator. One or both of the first actuator and second actuator may be used to move the shutter into a fully open position to allow light to pass, a fully closed position to block light from passing, or a range of partially open positions to allow a select amount of light to pass through an aperture. To improve power efficiency in actuating the actuators and moving the shutter, charge may be equalized between the first actuator and the second actuator prior to moving the shutter. In effect, the charge on one of two actuators in a dual-actuator configuration may be “recycled” from the previous shutter movement and transferred to the previously discharged actuator, thereby conserving energy.

In another implementation, the apparatus may form an image by reflection of ambient light originating from the front of the apparatus. In another implementation, the apparatus may form an image by reflection of light from a lamp or lamps positioned in the front of the display, i.e. by use of a front light. In still another implementation, the apparatus may work in a transflective mode, reflecting both ambient light originating from the front of the apparatus and light from a backlight. In general, in one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In certain implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

In the implementation depicted in FIG. 1A, each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material. In transflective implementations, each light modulator modulates both light from the backlight 105, as well as ambient light. In one implementation, the apertures are not completely cleared of the reflective material that would otherwise be etched away to form the aperture. The remaining reflective material reflects incident light back towards a viewer to form a part of the image 104. In another implementation, the apertures are fully cleared, and the ambient light is reflected by a front-facing reflective layer positioned behind the lamp 105.

The display apparatus 100 also includes a control matrix connected to the substrate and to the light modulators for providing a voltage to the actuators and for controlling the movement of the shutters. The control matrix provides electrical interconnections that allow for voltages to be applied to different components of the light modulator 102. In certain implementations, the control matrix includes a series of electrical interconnects (e.g., interconnects 110, 112, and 114), including a write-enable interconnect 110 (also referred to as a “scan-line interconnect”) per row of pixels, at least one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B is a block diagram of the display apparatus 100 of FIG. 1A, according to one illustrative implementation. Referring to FIGS. 1A and 1B, in addition to the elements of the display apparatus 100 described above, as depicted in the block diagram of FIG. 1B, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some implementations of the display apparatus, the data drivers 154 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104. In other cases the data drivers 154 are configured to apply only a reduced set of 2, 3, or 4 digital voltage levels to the control matrix. These voltage levels are designed to set, in digital fashion, either an open state or a closed state to each of the shutters 108.

The scan drivers 152 and the data drivers 154 are connected to digital controller circuit 156 (also referred to as the “controller 156”). The controller 156 controls how voltages are applied to different components of the light modulators to control how the light modulator moves relative to the aperture. The controller 156 includes an input processing module 158, which processes an incoming image signal 157 into a digital image format appropriate to the spatial addressing and the gray scale capabilities of the display 100. The pixel location and gray scale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display apparatus 100 optionally includes a set of common drivers 153, also referred to as common voltage sources. In some implementations the common drivers 153 provide a DC common potential to all light modulators within the array of light modulators 103, for instance by supplying voltage to a series of common interconnects 114. In other implementations the common drivers 153, following commands from the controller 156, issue voltage pulses or signals to the array of light modulators 103, for instance global actuation pulses which are capable of driving and/or initiating simultaneous actuation of all light modulators in multiple rows and columns of the array 103.

The drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 and lamps 162, 164, 166, and 167 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations the setting of an image frame to the array 103 is synchronized with the illumination of the lamps 162, 164, and 166 such that alternate image frames are illuminated with an alternating series of colors, such as red, green, and blue, to provide field sequential color.

In alternative implementations, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

In some implementations, the array of modulators may be divided into two or more groups with different spatial orientations with respect to their respective apertures. The input processing module 158 may additionally store a map of the spatial orientation of each pixel and process control signals prior to sending them on to the control matrix to determine the direction of motion to actuate each modulator from a light-blocking state to a light-transmissive state.

The display 100 includes a plurality of functional blocks including the timing control module 160, the frame buffer 159, scan drivers 152, data drivers 154, and drivers 153 and 168. Each block can be understood to represent either a distinguishable hardware circuit and/or a module of executable code. In some implementations the functional blocks are provided as distinct chips or circuits connected together by means of circuit boards and/or cables. Alternately, many of these circuits can be fabricated along with the pixel array 103 on the same substrate of glass or plastic. In other implementations, multiple circuits, drivers, processors, and/or control functions from block diagram 150 may be integrated together within a single silicon chip, which is then bonded directly to the transparent substrate holding pixel array 103.

The controller 156 includes a programming link 180 by which the addressing, color, and/or gray scale algorithms, which are implemented within controller 156, can be altered according to the needs of particular applications. Additionally, the programming link 180 may allow for different light modulator actuation techniques to be implemented, for example, to control the manner in which elements are moved within the light modulator. Thus, modulators that can move elements at different speeds may store and apply various algorithms to control the speed of modulation. In some implementations, the programming link 180 conveys information from environmental sensors, such as ambient light or temperature sensors, so that the controller 156 can adjust imaging modes or backlight power in correspondence with environmental conditions. The controller 156 also includes a power supply input 182 which provides the power needed for lamps as well as light modulator actuation. The drivers 152 153, 154, and/or 168 may also include or be associated with DC-DC converters for transforming an input voltage at 182 into various voltages sufficient for the actuation of shutters 108 or illumination of the lamps, such as lamps 162, 164, 166, and 167.

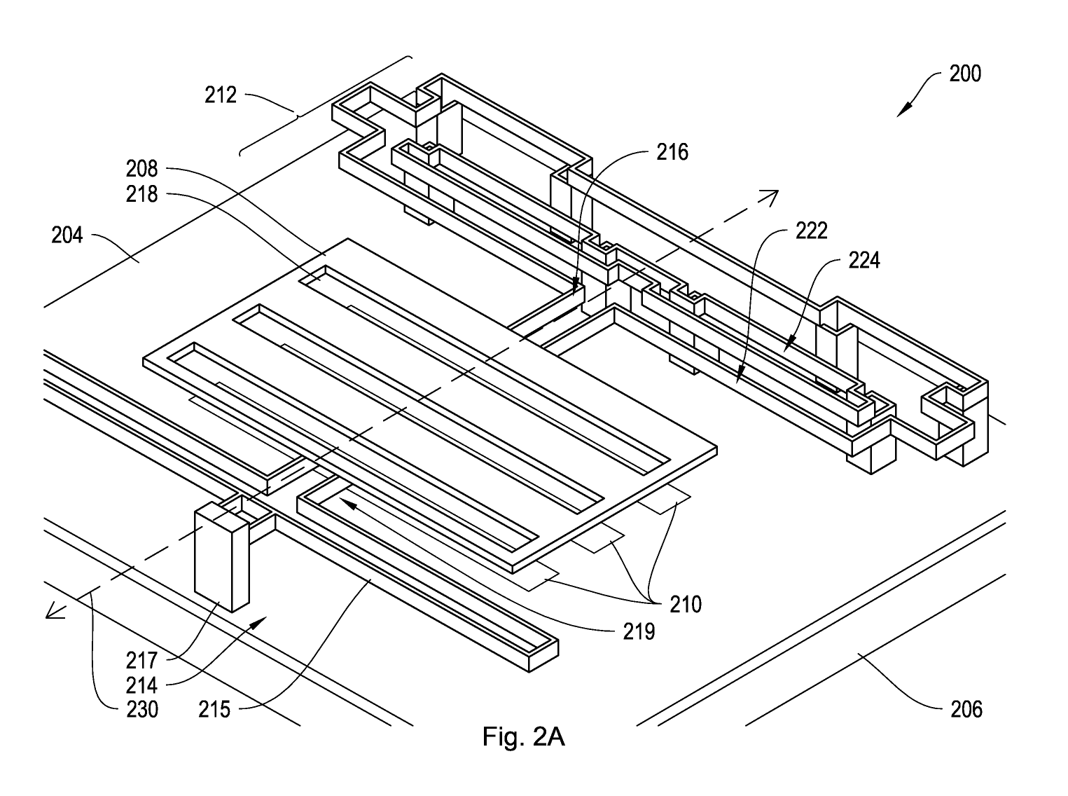

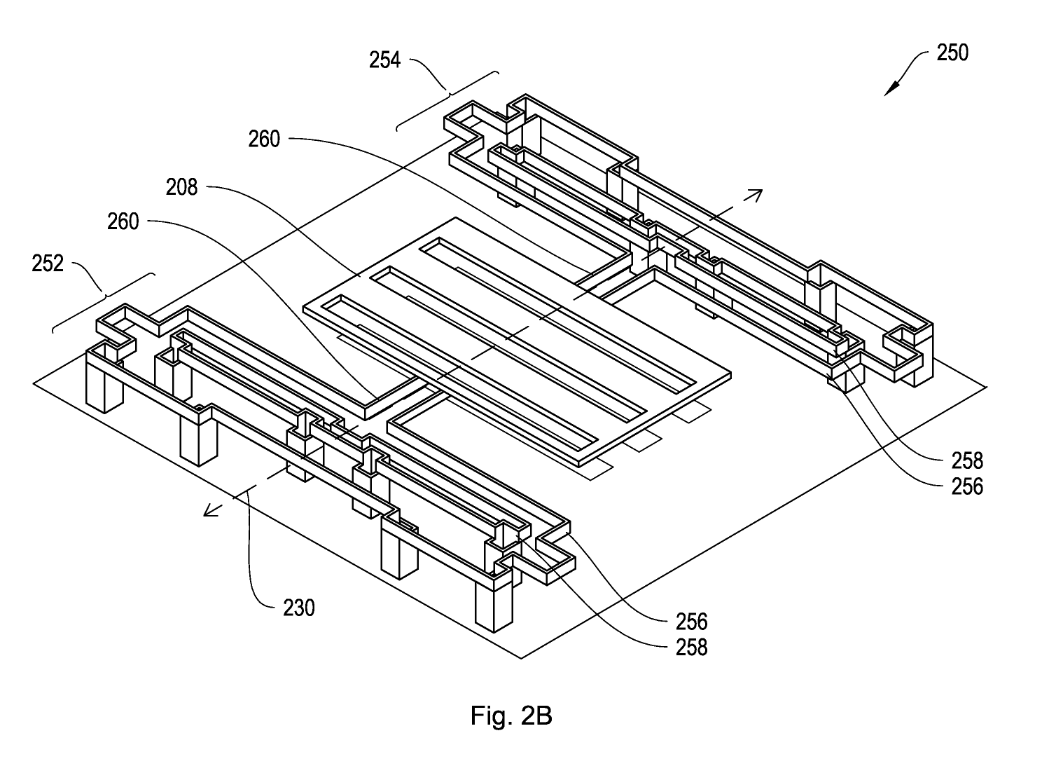

FIG. 2A depicts in more detail a light modulator of the type depicted in FIG. 1A. In particular, FIG. 2A depicts a light modulator 200 that may be used as the light modulators 102A-102D depicted in FIG. 1A. The light modulator 200 includes a MEMS shutter 208, and a single actuator 212 disposed on a substrate 204 that is positioned on a light guide 206. The light modulator 200 is backlit and lamps, such as the lamps 162-167 of FIG. 1B, can illuminate the light guide 206. The light guide 206 distributes the lamp light beneath the substrate 204 to allow light to pass through the apertures 210 that are formed within the substrate 204. The apertures 210 may be openings, such as holes, formed in the substrate 204 to provide a path for light within the light guide 206 to pass toward the shutter 208. Alternatively, the apertures 210 may be transparent regions formed in the surface of the substrate 204 to allow light to pass from the light guide 206 to the shutter 208. In either case, the apertures 210 allow light to pass from the light guide 206 toward the shutter 208. The shutter 208 includes three apertures 218 that can be aligned with the apertures 210 by action of the actuator 212. The apertures 218 in shutter 208 may be through holes formed within the shutter 208 to allow light passing through the shutter 208. In certain other implementations, the apertures 218 are formed by providing an optically transparent material that allows light passing through substrate apertures 210 to pass through the shutter 208. In the implementation depicted in FIG. 2A, the shutter 208 has three apertures 218, each of which is a rectangle and each of which can be aligned with a respective rectangular substrate aperture 210. In other implementations, the shutter 208 and the substrate 204 may have more or fewer apertures and the apertures may be of different geometries. The number of apertures and their geometries will vary according to the specifications provided for the display.

In the single actuator light modulator assembly 200, a spring 214 attaches to the shutter 208 on a side of the shutter 208 opposite the actuator 212. The spring 214 includes a compliant beam 215. The compliant beam 215 may be a pliant wall of elastic semiconductor material, such as a pliant wall of amorphous silicon. In the depicted implementation, the compliant beam 215 is formed as a rectangular wall of elastic semiconductor material. On one side, the compliant beam 215 couples to a standoff anchor 217 that fixes one side of the rectangular compliant beam 215 to the substrate 204. The standoff anchor 217 also holds the compliant beam 215 away from the surface of the substrate 204, so that there is a separation between the compliant beam 215 and the surface of the substrate 204. The opposite side of the rectangular compliant beam 215 couples to a pair of connecting arms 219 that couples the compliant beam 215 to the shutter 208. The spring 214 provides a restorative force to the shutter 208. For example, when the shutter 208 is moved toward the actuator 212 in response to the actuator 212 being activated by a controller, such as the controller 156, the compliant beam 215 deforms by extending in the direction that the shutter 208 has moved. The deformed compliant beam 215 generates a spring force that opposes the motion of the shutter 208 toward the actuator 212. When the controller 156 deactivates the actuator 212, the spring force of the compliant beam 215 pulls the shutter 208 away from the actuator 212 into the position the shutter 208 was in before the actuator 212 drove the shutter 208 away from the spring 214.

The shutter 208 connects to a connecting rod 216 that connects to the actuator 212. The actuator 212 drives the shutter 208 in a path along the direction of the axis 230. The actuator 212, in certain implementations, connects to an interconnect layer formed within the substrate 204. The interconnect layer provides a control matrix like the control matrix described with reference to FIGS. 1A and 1B. The actuator 212 includes an electrode 222 and an electrode 224. The electrode 222 connects to the connecting rod 216 that also connects to the shutter 208. The electrodes 222 and 224 and the connecting rod 218 may be made from any suitable material, and for example may be made from a semiconductor material such as amorphous silicon, epitaxial silicon or any other suitable material. The electrode 222 faces the electrode 224. In the implementation depicted in FIG. 2A, the connecting rod 216 couples the shutter 208 to the center of the electrode 222. The pair of electrodes 222 and 224 are drive electrodes that will, when activated, drive the electrode 222 toward the electrode 224, which drives the shutter 208 along a path defined by the axis 230. The spring 214 attached to the shutter 208 provides a restoring force that pulls the shutter 208 back toward the spring 214 when the actuator 212 is no longer actuating the drive electrodes 222 and 224.

FIG. 2B depicts, in more detail, an alternate implementation of a light modulator of the type depicted in FIG. 1A. In particular, FIG. 2B depicts a dual-actuated light modulator 250 having opposing actuators 252 and 254. The light modulator 250 of FIG. 2B may be used as the light modulators 102A-102D depicted in FIG. 1A. Each of actuators 252 and 254 is similar in structure and operation to the actuator 212 of FIG. 2A. In the implementation of FIG. 2B the shutter 208 connects on opposite sides to respective ones of the actuators 252 and 254. The actuators 252 and 254 and suspend the shutter 208 a distance away from the substrate 204.

Similarly to the single actuator light modulator assembly 200 of FIG. 2A, the actuators 252 and 254 each include electrodes 256 and 258. The electrode 222 connects to the connecting rod 216 that also connects to the shutter 208. The electrodes 256 and 258 may be made from any suitable material, and for example may be made from a semiconductor material such as amorphous silicon, epitaxial silicon or any other suitable material. The electrode 256 faces the electrode 258. In the implementation depicted in FIG. 2B, a connecting rod 260 couples the shutter 208 to the center of the electrodes 256 and 258. The pair of electrodes 256 and 258 are drive electrodes that will, when activated, drive the electrode 256 toward the electrode 258, which drives the shutter 208 along a path defined by the axis 230. Because the electrodes are conductive, a capacitance is created within the actuators. The capacitance may hold electrical charge at the actuators 252 and 254 to create an electrostatic force and hold the shutter 208 in position. In this implementation, a controller, such as controller 156, may control the operation of each actuator 252 and 254 to move the shutter 208 in a direction along the axis 230 to modulate light.

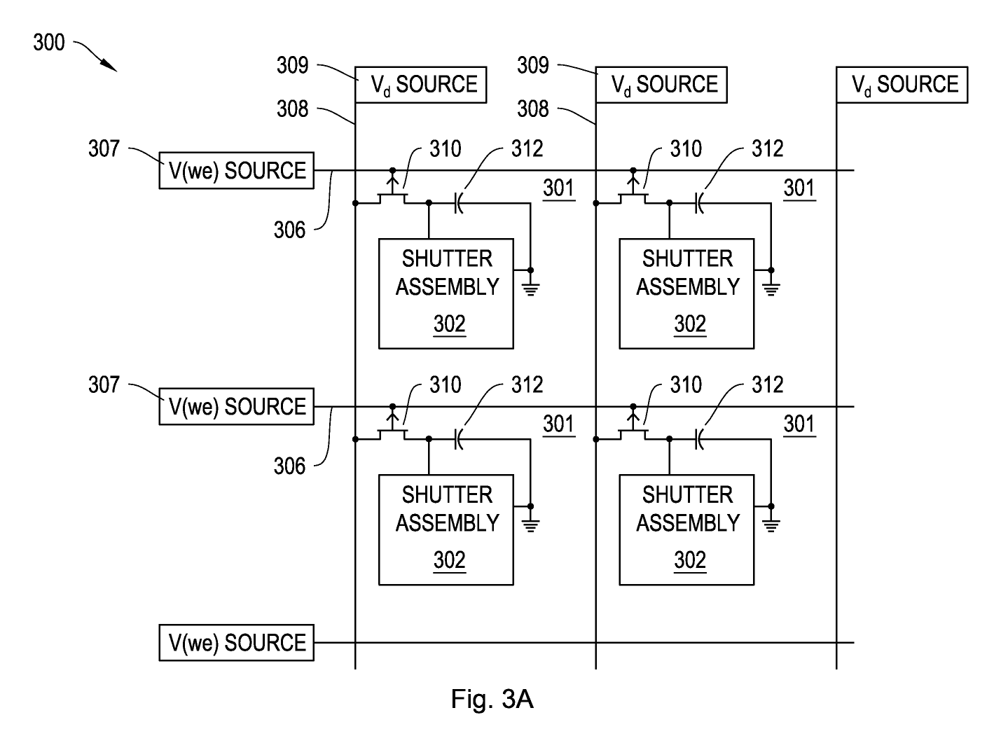

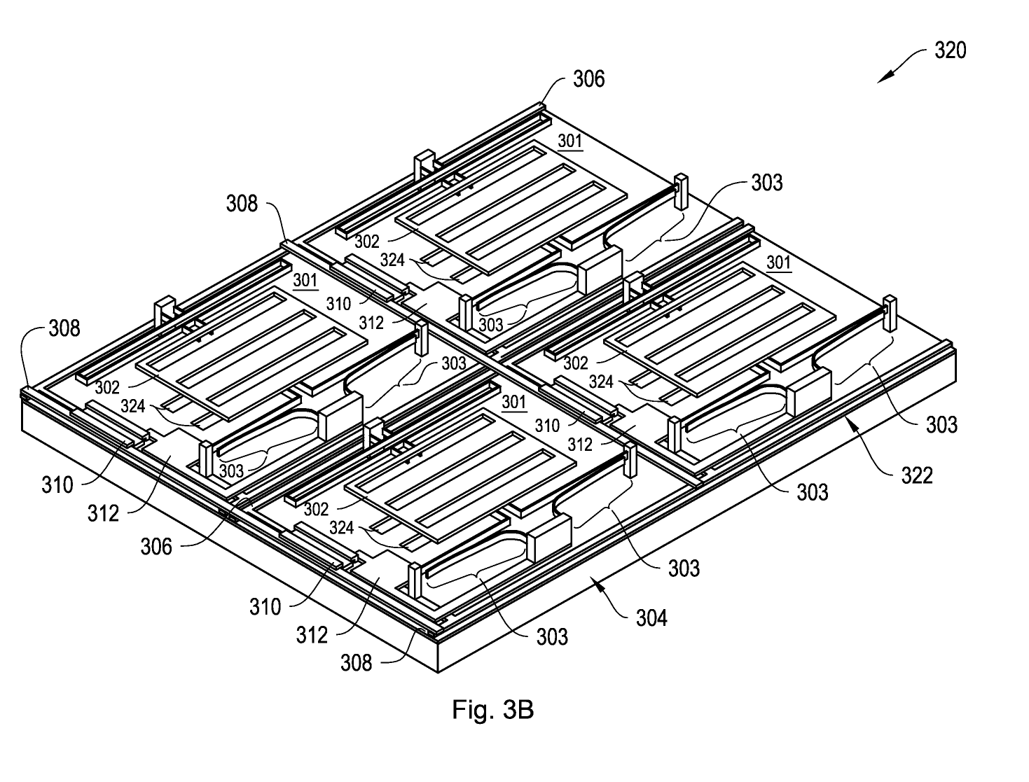

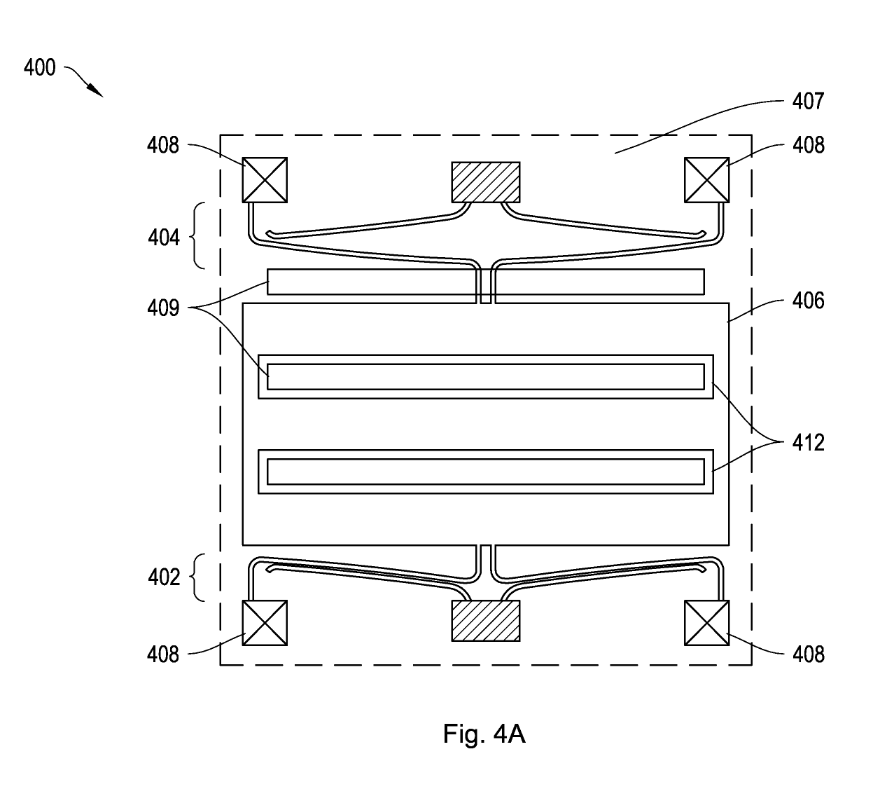

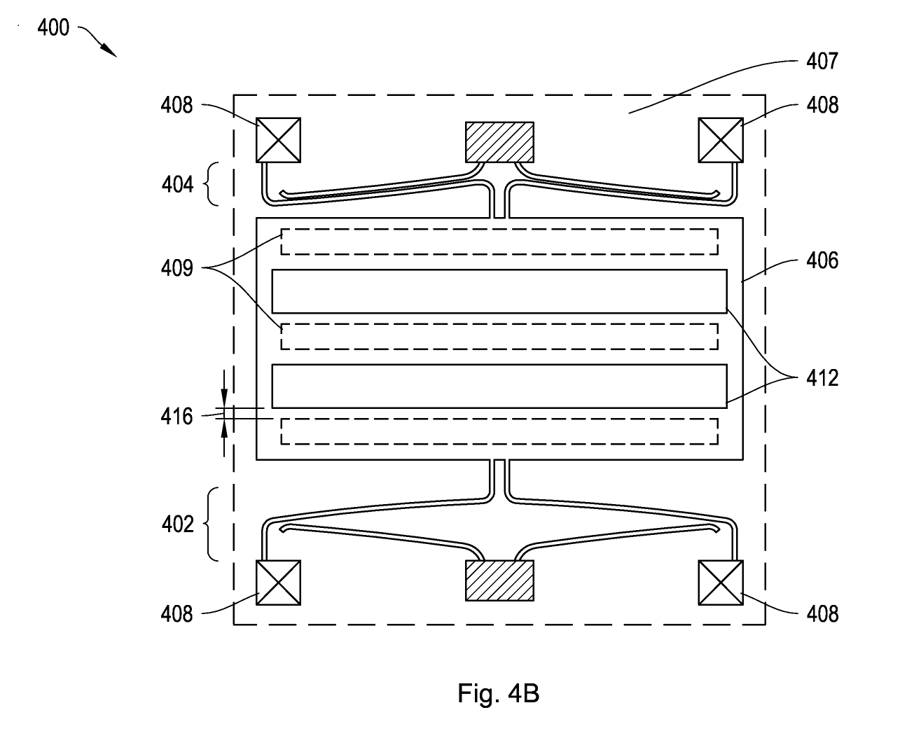

FIG. 3A is a schematic diagram of one control matrix 300 suitable for controlling the light modulators incorporated into the MEMS-based display apparatus 100 of FIG. 1A. FIG. 3B is a perspective view of an array 320 of shutter-based light modulators connected to the control matrix 300 of FIG. 3A. The control matrix 300 may address an array of pixels 320 (the “array 320”). In the example shown in FIGS. 3A and 3B, each pixel 301 includes an elastic shutter assembly 302 controlled by a single actuator 303. However, in certain implementations, each pixel 301 may include a dual-actuated shutter assembly, such as the shutter assembly shown in FIG. 2B or the shutter assemblies described with respect to FIGS. 4A and 4B, below. Each pixel 301 also includes an aperture layer 322 that includes apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. The shutter assemblies are fabricated using techniques similar to the art of micromachining or from the manufacture of micromechanical (i.e., MEMS) devices. For instance, the shutter assembly 302 can be formed from thin films of amorphous silicon, deposited by a chemical vapor deposition process.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

The control matrix 300 may be fabricated as a diffused or thin-film-deposited electrical circuit on the surface of a substrate 304 on which the shutter assemblies 302 are formed. The control matrix may also be fabricated as a layer within substrate 304 or may include elements (e.g., transistors, capacitors, electrically conducting lines, etc.) formed in the substrate 304. The control matrix 300 may include a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“V_{d} source”) 309 to the pixels 301 in a corresponding column of pixels 301. In implementations using dual-actuated shutter assemblies, the control matrix 300 may include two data interconnects for each pixel 301 for controlling the dual-actuated shutter assemblies 302. In control matrix 300, the data voltage V_{d} provides the majority of the energy for actuation of the shutter assemblies 302. Thus, the data voltage source 309 also serves as an actuation voltage source. In certain implementation, an actuation voltage source may provide the majority of energy for actuation of the shutter assemblies 300.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. For ease of description, FIG. 3A does not show the details of shutter assembly 302. However, as shown in FIG. 3B, shutter assembly 302 includes actuators 303 coupled to a shutter 302. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog grayscale, the data voltage V_{d} applied to each data interconnect 308 is varied in relation to the desired brightness of the pixel 301 located at the intersection of the write-enabled scan-line interconnect 306 and the data interconnect 308. In implementations providing digital control schemes, the data voltage V_{d} is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. Actuation can proceed after the write-enabling voltage has been removed from the row. The capacitors 312 also function as memory elements within the array 320, storing actuation instructions for periods as long as is needed for the illumination of an image frame.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division grayscale are possible where multiple MEMS light modulators in the pixel are provided, and where apertures 324, which are associated with each of the light modulators, have unequal areas.

FIGS. 4A and 4B are plan views of a dual-actuated shutter assemblies in the open and closed states respectively. In particular, FIGS. 4A and 4B illustrate an alternative shutter-based light modulator (shutter assembly) 400 suitable for inclusion in the MEMS-based display apparatus 100 of FIG. 1A, and in an array of pixels such as the array of pixels 300 and 320 of FIGS. 3A and 3B. The light modulator 400 is an example of a dual actuator shutter assembly, and is shown in FIG. 4A in an open state. FIG. 4B is a view of the dual actuator shutter assembly 400 in a closed state. In contrast to the single-actuator shutter assembly 200, shutter assembly 400 includes opposing actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of motion reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and the shutter-open actuator 402 is in its relaxed position. The shutter-close actuator 404 has been actuated, and the light blocking portions of shutter 406 are in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

To allow light with a variety of exit angles to pass through apertures 412 and 409 in the open state, it is advantageous to provide a width or size for shutter apertures 412 which is larger than a corresponding width or size of apertures 409 in the aperture layer 407. To effectively block light from escaping in the closed state, the light blocking portions of the shutter 406 may be arranged to overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage—displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

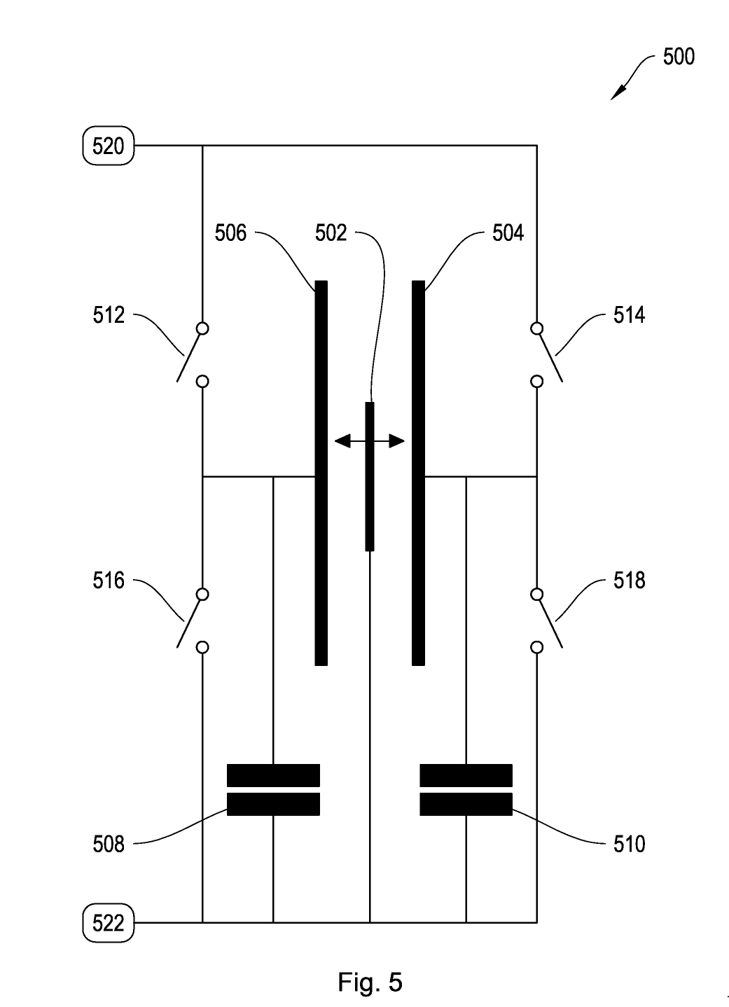

FIG. 5 is a circuit diagram 500 of control circuitry for controlling a dual-actuated light modulator, such as the dual-actuated light modulator 250 of FIG. 2B or the dual-actuated actuated light modulator 400 of FIGS. 4A and 4B. In particular, FIG. 5 illustrates the electrical connections for controlling a single pixel in an array of pixels, such as the array of pixels depicted in FIGS. 3A and 3B. Circuit diagram 500 includes light modulator 502 positioned between actuators 504 and 506. For simplicity, light modulator 502 and actuators 504 and 506 are represented as vertical lines in circuit diagram 500, however light modulator 502 and actuators 504 and 506 may resemble the structure of the dual-actuator light modulator assemblies of FIG. 2B or FIGS. 4A and 4B. Actuators 504 and 506 may include electrodes, as described in more detail with respect to FIGS. 2A and 2B. Actuators 504 and 506 may provide an electrostatic potential to move light modulator 502 to an open or closed positioned, as depicted in FIGS. 4A and 4B, respectively. Actuator 506 is electrically coupled to pre-charge switch 512 and to discharge switch 516. Actuator 504 is electrically coupled to pre-charge switch 514 and discharge switch 518. Actuator capacitors 508 and 510 are electrically connected to actuators 506 and 504, respectively. While actuator capacitors 508 and 510 are shown as independent elements in circuit diagram 500, in some implementations, actuators 506 and 504 may include actuator capacitors 508 and 510 as part of the actuator structure. Pre-charge switches 512 and 514 electrically connect actuators 506 and 504 to actuation voltage source 520. Actuation voltage source 520 provides a voltage high enough to actuate the light modulator 502. Discharge switches 516 and 518 connect actuators 506 and 504 to discharge voltage source 522. For example, voltage source 522 may be held at a ground voltage.

During operation of the control circuitry 500, pre-charge switches 512 and 514 are closed to pre-charge actuator capacitors 508 and 510 to an actuation voltage level. Next, pre-charge switches 512 and 514 are opened to disconnect the actuator capacitors 508 and 510 from the actuation voltage source 522. Depending on movement instructions provided to the pixel, one of discharge switches 516 or 518 is closed to discharge the voltage across one of the actuator capacitors 508 or 510 through discharge voltage source 522. For example, to move shutter 502 toward actuator 506, discharge switch 518 is closed to discharge the voltage across actuator capacitor 510. This results in actuator capacitor 508 becoming the high node capacitor and actuator capacitor 510 becoming the low node capacitor. Because of the voltage difference between the light modulator 502 and the actuator 506, the electrostatic force created between actuator 506 (charged to an actuation voltage level) and the light modulator 502 will cause the light modulator 502 to move toward actuator 506.

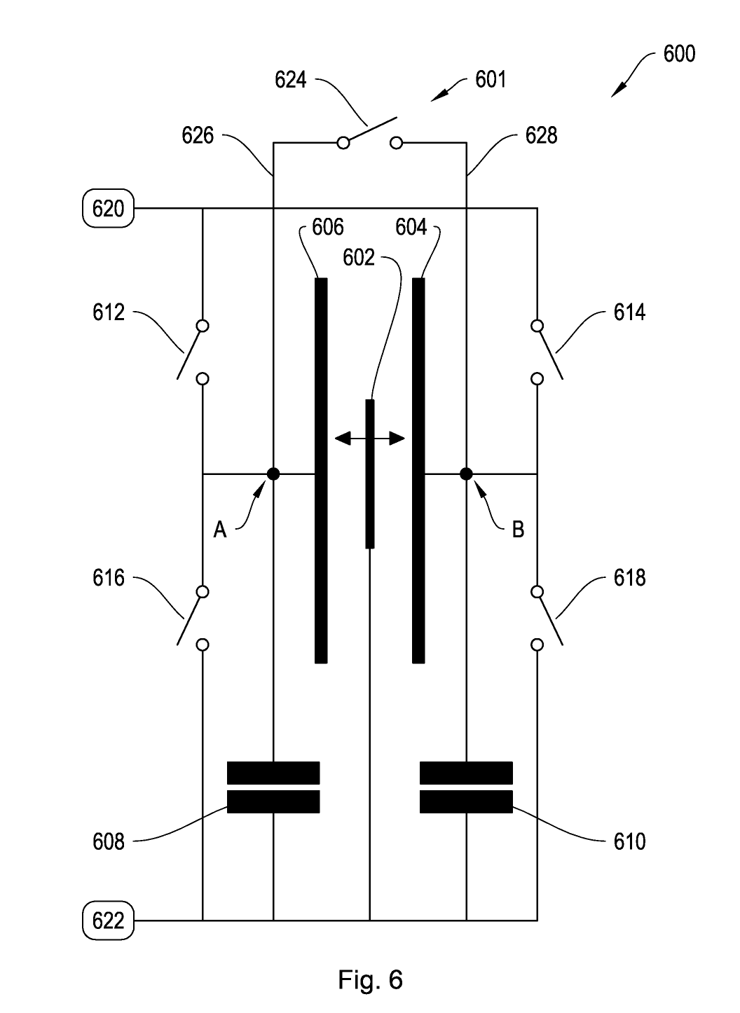

FIG. 6 is a circuit diagram of control circuitry 600 for controlling a dual-actuated light modulator. Control circuitry 600 includes a charge distribution circuit 601 for distributing charge between node A and node B. Distributing charge between node A and node B may include distributing charge between first actuator capacitor 608 and the second actuator capacitor 610. Distributing charge between node A and node B may also include distributing charge from parasitic capacitances throughout the control circuitry 600. In certain implementations, distributing charge between node A and node B includes distributing charge from a combination of sources in the control circuitry 600.

Charge distribution circuit 601 includes distribution switch 624 electrically coupled between node A and node B via electrical lines 626 and 628. Distribution switch 624 may include a transistor. In certain implementation, distribution switch 624 may include a mechanical relay, a solid state relay, an opto-electronic switch, or any other suitable distribution switch known to a person having ordinary skill in the art. The control circuitry 600 also includes light modulator 602 positioned between actuators 604 and 606. For simplicity, light modulator 602 and actuators 604 and 606 are represented as vertical lines in circuit diagram 600, however light modulator 602 and actuators 604 and 606 may resemble the structure of the dual-actuator light modulator assemblies of FIG. 2B or FIGS. 4A and 4B. Actuators 604 and 606 provide an electrostatic potential to move light modulator 602 to an open or closed position, as depicted in FIGS. 4A and 4B, respectively. Actuator 606 is electrically coupled to recharge switch 612 and to discharge switch 616. Actuator 604 is electrically coupled to recharge switch 614 and discharge switch 618. Actuator capacitors 608 and 610 are electrically connected to actuators 606 and 604, respectively. While actuator capacitors 608 and 610 are shown as independent elements in circuit diagram 600, in some implementations, actuators 606 and 604 may include actuator capacitors 608 and 610 as part of the actuator structure. While only two actuator capacitors 608 and 610 are shown, in certain implementation, more than two actuator capacitors may be used. Switches 612 and 614 electrically connect actuators 606 and 604 to actuation voltage source 620. Switches 616 and 618 connect actuators 606 and 604 to discharge voltage source 622. For example, voltage source 622 may be held at a ground voltage.

The control circuitry 600, including charge distribution circuit 601, of FIG. 6 allows for power saving and faster circuit operation speed when compared to control circuitry 500 of FIG. 5. Instead of pre-charging both actuator capacitors to the actuation voltage, charge is distributed from the high node capacitor to the low node capacitor using the charge distribution circuit 601. After charge equalization between capacitors, one capacitor is discharged and the other capacitor is re-charged to the actuation voltage level to move the shutter. As a result, power is saved because only half of the total charge is discharged from the low node capacitor, and the high node capacitor does not have to be charged from a ground state. In addition, circuit operation is faster because it takes a shorter amount of time to discharge only half of the actuation voltage, and a shorter amount of time to charge the capacitor from half actuation voltage to full actuation voltage than from ground voltage to full actuation voltage.

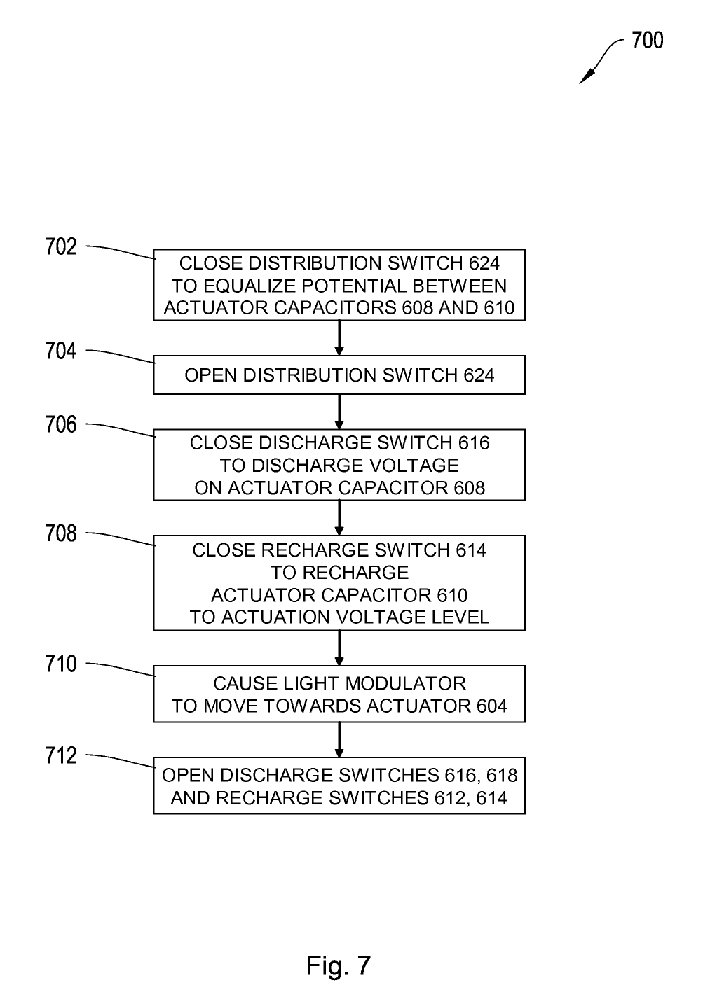

FIG. 7 is a block diagram depicting a method 700 for operating the control circuitry 600 of FIG. 6, including the charge distribution circuit 601. The method 700 will be described with respect to moving the light modulator 602 toward the actuator 604. However, in certain implementations, depending on specific image data or output sequence, the light modulator may move toward actuator 606 using a similar method as described in method 700. To move the light modulator 602 toward actuator 604, first the charge distribution switch 624 is closed, in block 702, to equalize the potential between first actuator capacitor 608 and the second actuator capacitor 610. When the charge distribution switch 624 is closed, charge stored on one or both of capacitors 608 and 610 is redistributed from the high node capacitor to the low node capacitor until the charge on both capacitors 608 and 610 is approximately equal. The distribution switch 624 is then opened in block 704 to remove the electrical connection between actuator capacitors 608 and 610.

Next, in block 706, the discharge switch 616 is closed to discharge the voltage across actuator capacitor 608. Because the charge was distributed between actuator capacitors 608 and 610 in block 702, only approximately half of the voltage needs to be discharged from actuator capacitor 608 during the discharge process of block 706. Thus, as a result of the charge distribution, the discharge process of block 706 saves power when compared to the discharge process for control circuitry 500 of FIG. 5. Accordingly, less power is wasted during the light modulator switching process, and discharging the actuator capacitor 608 takes less time when compared to discharging actuator capacitor 508.

In block 708, the re-charge switch 614 is closed to charge actuator capacitor 610 to an actuation voltage level. For example, the actuation voltage level may be a voltage high enough to actuate light modulator 602. The charge distribution of block 702 may be independent of the voltage range used to charge the actuator capacitors. For example, charge may be distributed in block 702 based on any level of actuation voltage. Because the charge was distributed between actuator capacitors 608 and 610 in block 702, the actuator capacitor 610 already has approximately one half of the actuation voltage already stored, and thus is charged from approximately one half of the actuation voltage level to the full actuation voltage level. Thus, the actuator charging process of method 700 saves power by recycling charge between the actuator capacitors 608 and 610 when compared to the charging process for control circuitry 500 of FIG. 5 which charges the actuator capacitor from a ground state. After the actuator capacitor 608 is discharged and the actuator capacitor 610 is charged to an actuation voltage, the light modulator 602 is primed for movement in block 710. Because the light modulator is held at a discharge voltage level (e.g., ground voltage), an electrostatic force is created between actuator 610 and the light modulator 602, causing the light modulator to move toward actuator 604.

Finally, in block 712, discharge switches 616 and 618 and re-charge switches 612 and 614 are opened to disconnect the actuator capacitors 608 and 610 from the actuation voltage source 620 and the discharge voltage source 622. The method 700 may begin again and repeat in accordance with the next set of light modulator movement instructions.

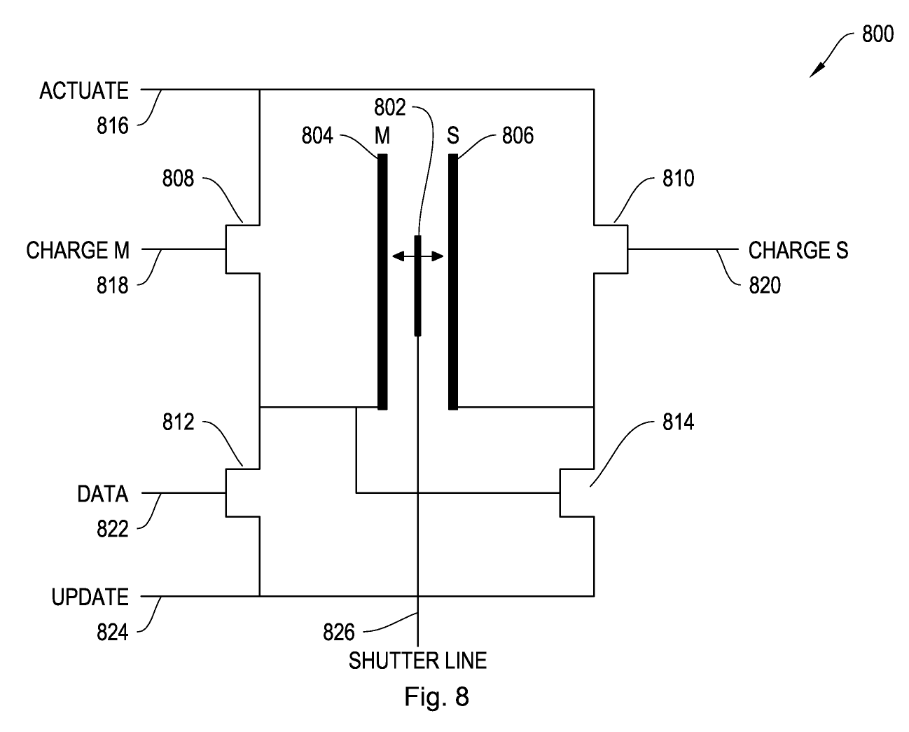

FIG. 8 is a circuit diagram of an alternate implementation of control circuitry 800 for controlling a dual-actuated light modulator. Control circuitry 800 is an example of a charge distribution circuit capable of distributing charge between actuator 804 and actuator 806. Control circuitry 800 includes a light modulator 802 (which may include a shutter) coupled between actuators 804 and 806. For simplicity, light modulator 802 and actuators 804 and 806 are represented as vertical lines in circuit diagram 800, however light modulator 802 and actuators 804 and 806 may resemble the structure of the dual-actuator light modulator assemblies of FIG. 2B or FIGS. 4A and 4B. Actuators 804 and 806 may provide an electrostatic potential to move light modulator 802 to an open or closed positioned, as depicted in FIGS. 4A and 4B, respectively. While not shown in circuit diagram 800, actuators 804 and 806 may include actuator capacitors as described with respect to FIG. 2B. In some implementation, the actuator capacitors may be additional actuators 804 and 806.

Control circuitry 800 includes switch 808 coupling actuate line 816 to actuator 804 and switch 810 coupling the actuate line 816 to actuator 806. The gate of switch 808 is electrically coupled to charge M line 818 and the gate of switch 810 is electrically coupled to charge S line 820. Switch 812 electrically couples actuator 804 to update line 824. The gate of switch 812 is electrically coupled to data line 822. Switch 814 electrically couples actuator 806 to update line 814. The gate of switch 814 is electrically coupled to actuator 804. Shutter line 826 is electrically coupled to shutter 802 to provide a voltage to light modulator 802. In certain implementation, shutter line 826 provides a ground voltage to light modulator 802. Switches 808, 810, 812 and 814 may be transistors or any other switch known to those having ordinary skill in the art.

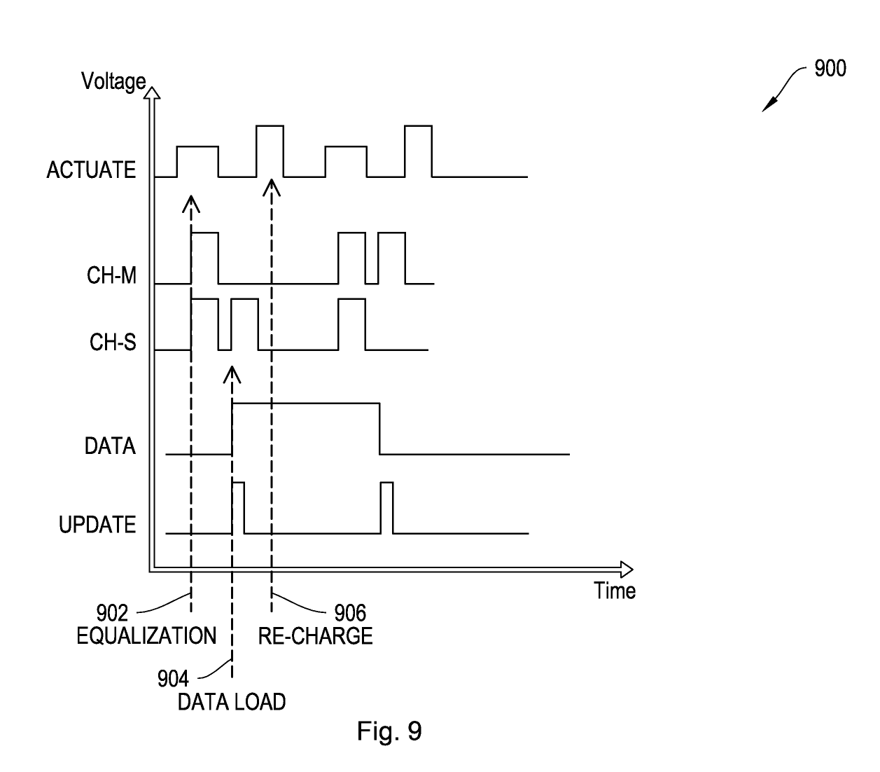

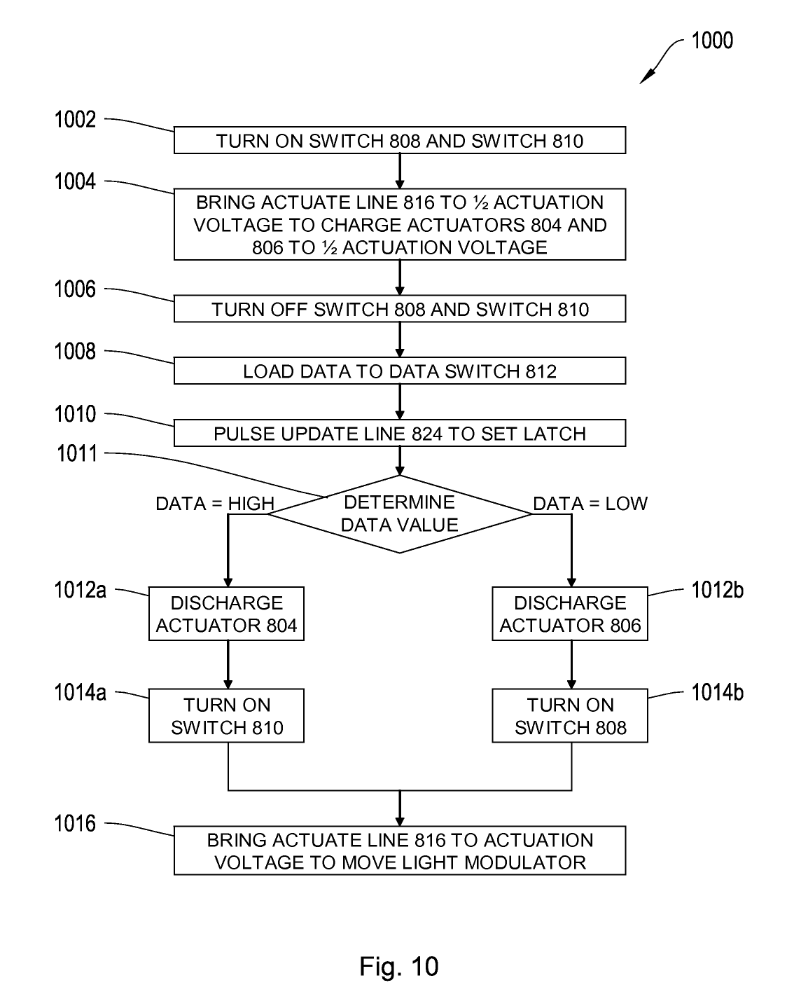

FIG. 9 is a timing diagram 900 depicting a method of driving a circuit, such as the control circuit 800 of FIG. 8. FIG. 9 shows the voltage applied to each of the Actuate line 816, the Charge M line 818, the Charge S line 820, the Data line 822, and Update line 824 over time. The magnitude of the voltage applied to each line corresponds to the height of the pulse illustrated in timing diagram 900. FIG. 10 is a block diagram of a method 1000 for operating the control circuit 800 of FIG. 8. The control circuit 800 may be operated to equalize potential between actuator 804 and 806, and move the light modulator 802 according to the method 1000 of FIG. 10 and the timing diagram 900 of FIG. 900.

Referring to FIGS. 8, 9 and 10 together, potential is equalized between actuators 804 and 806 by turning ON both switches 808 and 810 and applying an equal voltage to each of actuators 804 and 806 prior to discharging one of the capacitors and moving the light modulator. However, instead of pre-charging the actuators 804 and 806 to a full actuation voltage, the actuators 808 and 810 are equalized at approximately ½ actuation voltage. As a result, only one-half actuation voltage is discharged to move the shutter instead of a full actuation voltage and power is conserved. In block 1002, switches 808 and 810 are turned ON by applying a ‘high’ voltage to charge M line 818 and charge S line 820, respectively. In block 1004, during charge equalization, the actuate line 816 is brought to one-half actuation voltage to charge actuators 804 and 806 to one-half of an actuation voltage. As shown in timing diagram 900, application of one-half actuation voltage to the actuate line 816 may occur at time 902, just before or at approximately the same time that switches 808 and 810 are turned ON. In certain implementations, more than one-half actuation voltage is applied in block 1004. In other implementations, less than one-half actuation voltage is applied in block 1004.

In block 1006, after actuators 804 and 806 are charged to one-half actuation voltage, switches 808 and 810 are turned OFF to disconnect the actuators 804 and 806 from the actuate line 816. In block 1008, data is loaded to switch 812 via data line 822 at time 904. For example, the data may be a high voltage or a low voltage and may indicate the intended light modulator position (e.g., ‘open’ or ‘closed’). As described with respect to FIG. 1B, the data voltage provided to a single pixel may be derived from image data received by a display device. In the example shown in timing diagram 900, a ‘high’ data voltage is applied via data line 822 at time 904. In block 1010, the update line 824 is pulsed to set the latch.

In block 1011, the data loaded to data switch 812 is determined. If the data loaded to data switch 812 in block 1008 is ‘high,’ then actuator 804 is discharged in block 1012a. For example, to discharge actuator 804, actuator 804 may be electrically connected to a ground node. In block 1014a, a ‘high’ voltage is applied to switch 810 via charge S line 820 to turn switch 810 ON. In block 1016, a full actuation voltage is applied to actuate line 816 at time 906 to re-charge actuator 806 to a full actuation voltage. If the light modulator is held at a voltage lower than the actuation voltage (e.g., ground), an electrostatic force is created between the light modulator and actuator 806 and the light modulator will move toward actuator 806. Because one-half actuation voltage was previously distributed to actuator 806 during charge equalization of block 1004, actuator 806 can be fully charged to an actuation voltage in block 1016 using less power and in less time than if charge equalization of block 1004 was not executed.

If the data loaded to data switch 812 in block 1008 is ‘low,’ then actuator 806 is discharged in block 1012b. In block 1014b, a ‘high’ voltage is applied to switch 808 via charge M line 818 to turn switch 808 ON. In block 1016, a full actuation voltage is applied to actuate line 816 to re-charge actuator 804 to a full actuation voltage. If the light modulator is held at a voltage lower than the actuation voltage (e.g., ground), an electrostatic force is created between the light modulator and actuator 804 and the shutter will move toward actuator 804. Because one-half actuation voltage was previously distributed to actuator 806 during charge equalization of block 1004, actuator 804 can be fully charged to an actuation voltage in block 1016 using less power and in less time than if charge equalization of block 1004 did not occur.

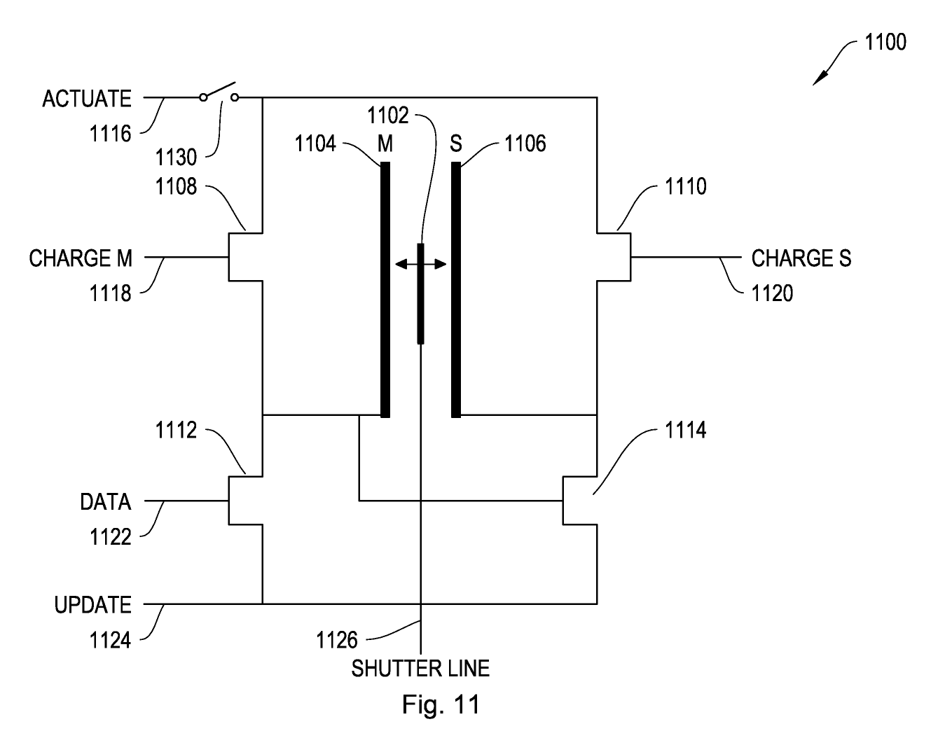

FIG. 11 is a circuit diagram of an alternate implementation of control circuitry 1100 for controlling a dual-actuated light modulator. Control circuitry 1100 is an example of a charge distribution circuit capable of distributing charge between actuator 1104 and actuator 1106. Control circuitry 1100 includes a light modulator 1102 coupled between actuators 1104 and 1106. For simplicity, light modulator 1102 and actuators 1104 and 1106 are represented as vertical lines in circuit diagram 1100, however light modulator 1102 and actuators 1104 and 1106 may resemble the structure of the dual-actuator light modulator assemblies of FIG. 2B or FIGS. 4A and 4B. Actuators 1104 and 1106 may provide an electrostatic potential to move light modulator 1102 to an open or closed positioned, as depicted in FIGS. 4A and 4B, respectively. While not shown in circuit diagram 1100, actuators 1104 and 1106 may include actuator capacitors. In some implementation, the actuator capacitors may be in addition to actuators 1104 and 1106.

Control circuitry 1100 includes switch 1108 coupling actuate line 1116 to actuator 1104, and switch 1110 coupling the actuate line 1116 to actuator 1106. The gate of switch 1108 is electrically coupled to charge M line 1118 and the gate of switch 1110 is electrically coupled to charge S line 1120. Switch 1112 electrically couples actuator 1104 to update line 1124. The gate of switch 1112 is electrically coupled to data line 1122. Switch 1114 electrically couples actuator 1106 to update line 1114. The gate of switch 1114 is electrically coupled to actuator 1104. Shutter line 1126 is electrically coupled to shutter 1102 to provide a voltage to shutter 1102. In certain implementation, shutter line 1126 provides a ground voltage to light modulator 1102. Control circuitry 1100 further includes actuate switch 1130 coupled between the actuate line 1116 and switches 1108 and 1110. Switches 1108, 1110, 1112, 1114 and 1130 may be transistors or any other switch known to those having ordinary skill in the art.

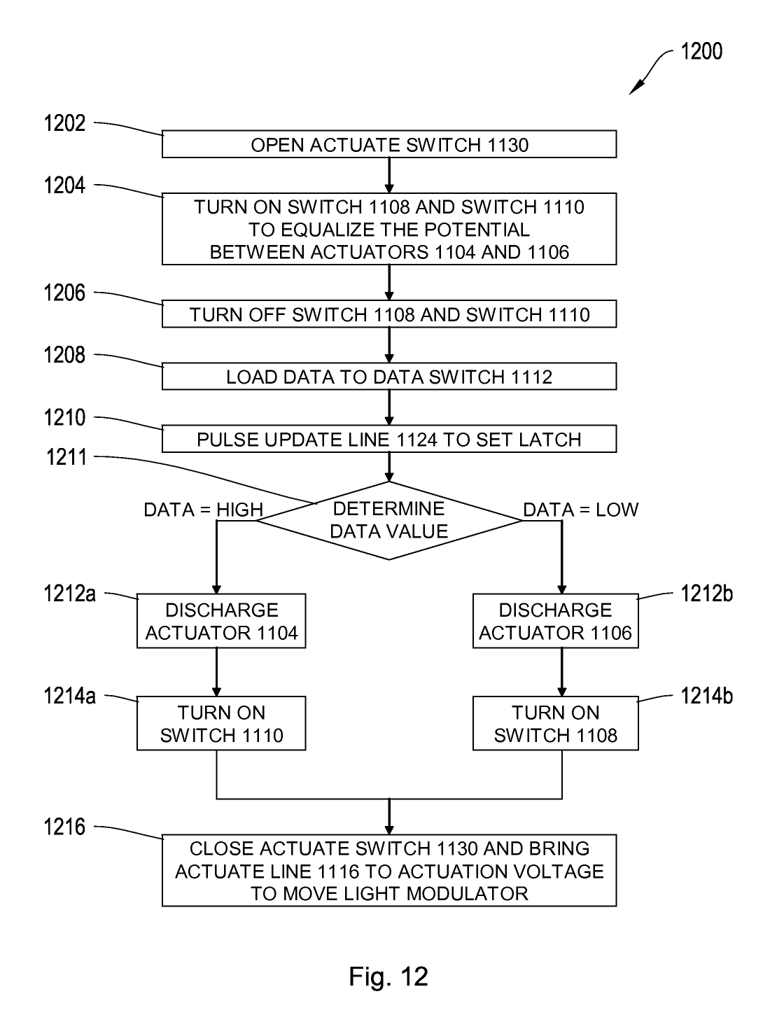

FIG. 12 is a block diagram depicting a method 1200 for operating the control circuit 1100 of FIG. 11. In block 1202, actuate switch 1130 is opened to electrically disconnect actuators 1104 and 1106 from actuate line 1116. In block 1204, a ‘high’ voltage is applied to the gate of switch 1108 via charge M line 1118 to turn switch 1108 ON, and, simultaneously, a ‘high’ voltage is applied to the gate of switch 1110 via charge S line 1120 to turn switch 1110 ON. By concurrently turning both switch 1108 and switch 1110 ON, charge is distributed between actuators 1104 and 1106 until there is approximately equal voltage across both actuators 1104 and 1106. In block 1206, switches 1108 and 1110 are turned OFF to electrically disconnect actuator 1104 from actuator 1106.

In block 1208, data is loaded to switch 1112 via data line 1122. For example, the data may be a high voltage or a low voltage and may indicate the intended light modulator position (e.g., ‘open’ or ‘closed’). In block 1210, the update line 1124 is pulsed to set the latch.

In block 1211, the data loaded to data switch 1112 is determined. If the data loaded to data switch 1112 in block 1208 is ‘high,’ then actuator 1104 is discharged in block 1212a. In block 1214a, a ‘high’ voltage is applied to switch 1110 via charge S line 1120 to turn switch 1110 ON. In block 1216, actuate switch 1130 is closed and a full actuation voltage is applied to actuate line 1116 to re-charge actuator 1106 to a full actuation voltage. If the light modulator is held at a voltage lower than the actuation voltage (e.g., ground), an electrostatic force is created between the light modulator and actuator 1106 and the shutter will move toward actuator 1106. Because the charge was previously distributed between actuators 1104 and 1106 during charge equalization of block 1204, actuator 1106 can be fully charged to an actuation voltage in block 1216 using less power and in less time than if charge equalization of block 1204 was not executed.

If the data loaded to data switch 1112 in block 1208 is ‘low,’ then actuator 1106 is discharged in block 1212b. In block 1214b, a ‘high’ voltage is applied to switch 1108 via charge M line 1118 to turn switch 1108 ON. In block 1216, actuate switch 1130 is closed and a full actuation voltage is applied to actuate line 1116 to re-charge actuator 1104 to a full actuation voltage. If the light modulator is held at a voltage lower than the actuation voltage (e.g., ground), an electrostatic force is created between the light modulator and actuator 1104 and the shutter will move toward actuator 1104. Because the charge was previously distributed between actuators 1104 and 1106 during charge equalization of block 1204, actuator 1104 can be fully charged to an actuation voltage in block 1216 using less power and in less time than if charge equalization of block 1204 was not executed.

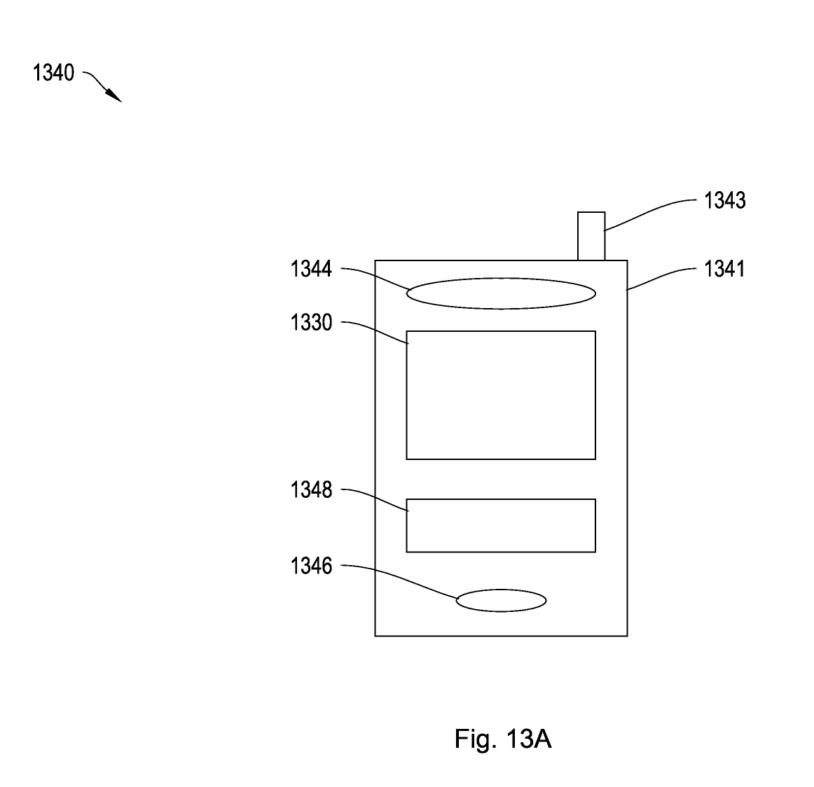

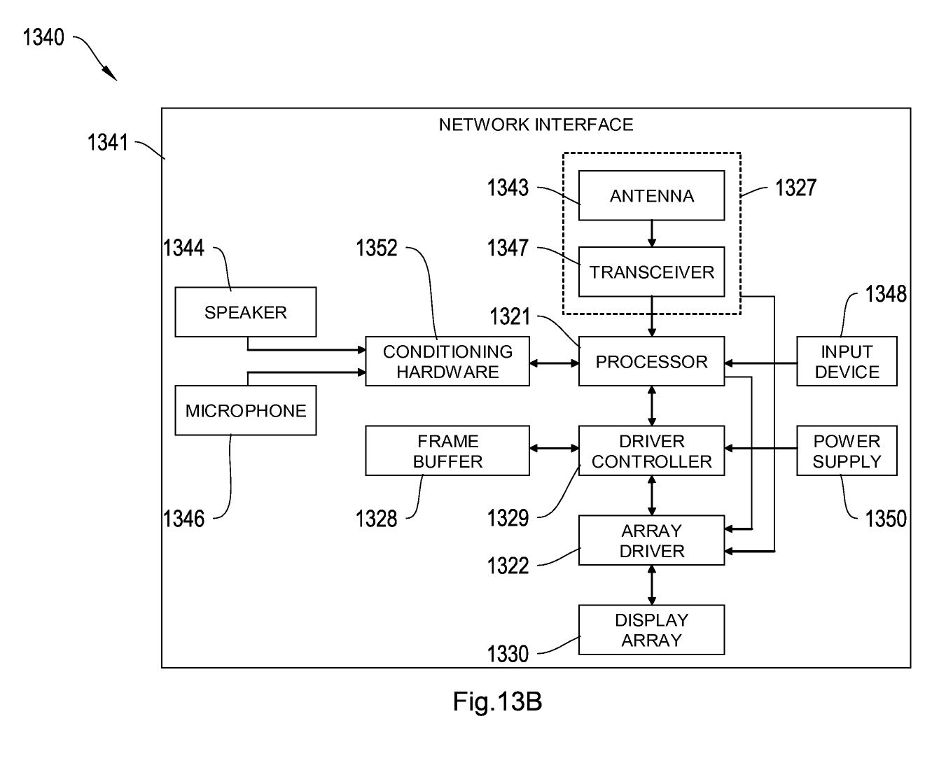

FIGS. 13A and 13B are system block diagrams illustrating a display device 640 that includes a plurality of MEMS light modulator display elements. The display device 640 can be, for example, a smart phone, a cellular or mobile telephone. However, the same components of the display device 640 or slight variations thereof are also illustrative of various types of display devices such as televisions, computers, tablets, e-readers, hand-held devices and portable media devices.

The display device 640 includes a housing 641, a display 630, an antenna 643, a speaker 645, an input device 648 and a microphone 646. The housing 641 can be formed from any of a variety of manufacturing processes, including injection molding, and vacuum forming. In addition, the housing 641 may be made from any of a variety of materials, including, but not limited to: plastic, metal, glass, rubber and ceramic, or a combination thereof. The housing 641 can include removable portions (not shown) that may be interchanged with other removable portions of different color, or containing different logos, pictures, or symbols.

The display 630 may be any of a variety of displays, including a bi-stable or analog display, as described herein. The display 630 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 640 are schematically illustrated in FIG. 13B. The display device 640 includes a housing 641 and can include additional components at least partially enclosed therein. For example, the display device 640 includes a network interface 627 that includes an antenna 643 which can be coupled to a transceiver 647. The network interface 627 may be a source for image data that could be displayed on the display device 640. Accordingly, the network interface 627 is one example of an image source module, but the processor 621 and the input device 648 also may serve as an image source module. The transceiver 647 is connected to a processor 621, which is connected to conditioning hardware 652. The conditioning hardware 652 may be configured to condition a signal (such as filter or otherwise manipulate a signal). The conditioning hardware 652 can be connected to a speaker 645 and a microphone 646. The processor 621 also can be connected to an input device 648 and a driver controller 629. The driver controller 629 can be coupled to a frame buffer 628, and to an array driver 622, which in turn can be coupled to a display array 630. One or more elements in the display device 640, including elements not specifically depicted in FIG. 13A, can be configured to function as a memory device and be configured to communicate with the processor 621. In some implementations, a power supply 650 can provide power to substantially all components in the particular display device 40 design.

The network interface 627 includes the antenna 643 and the transceiver 647 so that the display device 640 can communicate with one or more devices over a network. The network interface 627 also may have some processing capabilities to relieve, for example, data processing requirements of the processor 621. The antenna 643 can transmit and receive signals. In some implementations, the antenna 643 transmits and receives RF signals according to the IEEE 16.11 standard, including IEEE 16.11(a), (b), or (g), or the IEEE 802.11 standard, including IEEE 802.11 a, b, g, n, and further implementations thereof. In some other implementations, the antenna 643 transmits and receives RF signals according to the Bluetooth® standard. In the case of a cellular telephone, the antenna 643 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 647 can pre-process the signals received from the antenna 643 so that they may be received by and further manipulated by the processor 621. The transceiver 647 also can process signals received from the processor 621 so that they may be transmitted from the display device 640 via the antenna 643.

In some implementations, the transceiver 647 can be replaced by a receiver. In addition, in some implementations, the network interface 627 can be replaced by an image source, which can store or generate image data to be sent to the processor 621. The processor 621 can control the overall operation of the display device 640. The processor 621 receives data, such as compressed image data from the network interface 627 or an image source, and processes the data into raw image data or into a format that can be readily processed into raw image data. The processor 621 can send the processed data to the driver controller 629 or to the frame buffer 628 for storage. Raw data typically refers to the information that identifies the image characteristics at each location within an image. For example, such image characteristics can include color, saturation and gray-scale level.

The processor 621 can include a microcontroller, CPU, or logic unit to control operation of the display device 640. The conditioning hardware 652 may include amplifiers and filters for transmitting signals to the speaker 645, and for receiving signals from the microphone 646. The conditioning hardware 652 may be discrete components within the display device 640, or may be incorporated within the processor 621 or other components.

The driver controller 629 can take the raw image data generated by the processor 621 either directly from the processor 621 or from the frame buffer 628 and can re-format the raw image data appropriately for high speed transmission to the array driver 622. In some implementations, the driver controller 629 can re-format the raw image data into a data flow having a raster-like format, such that it has a time order suitable for scanning across the display array 630. Then the driver controller 629 sends the formatted information to the array driver 622. Although a driver controller 629, such as an LCD controller, is often associated with the system processor 621 as a stand-alone Integrated Circuit (IC), such controllers may be implemented in many ways. For example, controllers may be embedded in the processor 621 as hardware, embedded in the processor 621 as software, or fully integrated in hardware with the array driver 622.

The array driver 622 can receive the formatted information from the driver controller 629 and can re-format the video data into a parallel set of waveforms that are applied many times per second to the hundreds, and sometimes thousands (or more), of leads coming from the display's x-y matrix of display elements.

In some implementations, the driver controller 629, the array driver 622, and the display array 630 are appropriate for any of the types of displays described herein. For example, the driver controller 629 can be a conventional display controller or a bi-stable display controller (such as an IMOD display element controller). Additionally, the array driver 622 can be a conventional driver or a bi-stable display driver (such as an IMOD display element driver). Moreover, the display array 630 can be a conventional display array or a bi-stable display array (such as a display including an array of IMOD display elements). In some implementations, the driver controller 629 can be integrated with the array driver 622. Such an implementation can be useful in highly integrated systems, for example, mobile phones, portable-electronic devices, watches or small-area displays.

In some implementations, the input device 648 can be configured to allow, for example, a user to control the operation of the display device 640. The input device 648 can include a keypad, such as a QWERTY keyboard or a telephone keypad, a button, a switch, a rocker, a touch-sensitive screen, a touch-sensitive screen integrated with the display array 630, or a pressure- or heat-sensitive membrane. The microphone 646 can be configured as an input device for the display device 640. In some implementations, voice commands through the microphone 646 can be used for controlling operations of the display device 640.

The power supply 650 can include a variety of energy storage devices. For example, the power supply 650 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 650 also can be a renewable energy source, a capacitor, or a solar cell, including a plastic solar cell or solar-cell paint. The power supply 650 also can be configured to receive power from a wall outlet.

In some implementations, control programmability resides in the driver controller 629 which can be located in several places in the electronic display system. In some other implementations, control programmability resides in the array driver 622. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical device comprising:
a movable element being movably responsive to a first actuator and second actuator, the first actuator including a first capacitor and the second actuator including a second capacitor; and
a charge distribution circuit arranged to electronically couple the first capacitor to the second capacitor and capable of equalizing a potential between the first capacitor and second capacitor.

2. The electromechanical device of claim 1, wherein the charge distribution circuit includes a single switch.

3. The electromechanical device of claim 1, wherein the charge distribution circuit includes at least a first switch and a second switch.

4. The electromechanical device of claim 3, wherein the charge distribution circuit further comprises a voltage interconnect coupled to the first switch and the second switch.

5. The electromechanical device of claim 1, further comprising:
a display;
a processor that is configured to communicate with the display, the processor being configured to process image data; and
a memory device that is configured to communicate with the processor.

6. The electromechanical device of claim 5, further comprising:
a driver circuit configured to send at least one signal to the display; and
a controller configured to send at least a portion of the image data to the driver circuit.

7. The electromechanical device of claim 5, further comprising:
an image source module configured to send the image data to the processor, wherein the image source module comprises at least one of a receiver, transceiver, and transmitter.

8. The electromechanical device of claim 5, further comprising:
an input device configured to receive input data and to communicate the input data to the processor.

9. A display comprising:
an array of pixels comprising, for each pixel, a first actuator capacitor, a second actuator capacitor and a light modulator being electronically coupled to the first and second actuator capacitors; and
a control matrix associated with the array of pixels including, for each pixel:
a charge distribution circuit arranged to electronically couple the first actuator capacitor to the second actuator capacitor, and equalize a potential between the first actuator capacitor and the second actuator capacitor.

10. The display of claim 9, wherein the charge distribution circuit includes a single switch.

11. The display of claim 9, wherein the charge distribution circuit includes at least a first switch and a second switch.

12. The display of claim 11, wherein the charge distribution circuit further comprises a voltage interconnect coupled to the first switch and the second switch.

13. A method for addressing an array of pixels in a display wherein a given pixel includes a light modulator coupled between first and second actuator capacitors, the method comprising:
equalizing a first potential of the first actuator capacitor and a second potential of the second actuator capacitor;
loading data to the array of pixels; and
for a given pixel,
discharging the first actuator capacitor based on the data;
re-charging the second actuator capacitor to an actuation voltage based on the data; and
causing the light modulator to move in response to a potential difference between the light modulator and at least one of the first and second actuator capacitors.

14. The method of claim 13, wherein the potential between the first actuator capacitor and the second actuator capacitor is equalized prior to discharging the first actuator capacitor and prior to causing the light modulator to move.

15. The method of claim 13, wherein equalizing the potential between the first actuator capacitor and the second actuator capacitor comprises moving charge from a high level node to a low level node.

16. The method of claim 13, wherein equalizing the potential between the first actuator capacitor and the second actuator capacitor comprises applying a first voltage to both the first actuator capacitor and the second actuator capacitor.

17. The method of claim 16, wherein the first voltage is approximately half of the actuation voltage.

18. The method of claim 13, wherein discharging the first actuator capacitor comprises discharging approximately half of the actuation voltage.

19. The method of claim 13, wherein re-charging the second actuator capacitor comprises re-charging from approximately half of the actuation voltage.

20. The method of claim 13, wherein loading data to the array of pixels comprises setting a latch in a first state.
